(19) United States
(12) Patent Application Publication
(10) Pub. No.: US 2014/0060079 A1
(43) Pub. Date: Mar. 6, 2014

(54) AEROENGINE ARRANGEMENT

(71) Applicant: Rolls-Royce PLC, (US)

(72) Inventor: Lawrence David FOSTER, Derby (GB)

(73) Assignee: ROLLS-ROYCE PLC, London (GB)

(21) Appl. No.: 13/680,875

(22) Filed: Nov. 19, 2012

(30) Foreign Application Priority Data
Dec. 22, 2011 (GB) 1122076.1

(51) Int. Cl. F02C 7/32

(52) U.S. Cl. CPC F02C 7/32
USPC 60/798; 29/893.1

(57) ABSTRACT

A core engine for a gas turbine engine, the core engine having a rotational axis, a casing and further comprises a gearbox assembly, a radial drive arrangement, pipes and connections and a connection structure; the radial drive arrangement drivingly connects the core engine to the gearbox assembly; the pipes and connections extend from the gearbox assembly to the core engine and the gearbox assembly is radially spaced from the casing by connection structure. A method of assembling the gas turbine engine includes the steps of axially translating the core engine and the fan casing so that the gearbox is adjacent the fan casing and attaching the gearbox assembly to the fan casing.

The present invention relates to an aeroengine arrangement suitable for transportation and in particular one in which a fan casing is separable from the remainder of the aeroengine.

Some conventional gas turbine engines are designed with an accessory gearbox mounted on the engine's fan casing. This is for accessibility and because it is a relatively cool environment for both the gearbox and its associated units such as generators, fuel pumps and oil pumps.

The fan casing is only removed and replaced at its initial assembly factory or an engine overhaul base because there are certification constraints with respect to disconnecting and re-connecting a number of high pressure fuel lines and other pipes and services. Removing the fan casing involves disconnecting all the pipe-work from the core engine to the gearbox including oil lines, fuel lines, electrical cables and the gearbox's drive shaft. Thus conventional aero-gas turbine engines must be transported with the fan casing assembled to the core engine. Particularly, but not exclusively, with today's very high bypass engines the fan casing diameter is such that transportation is very difficult, time consuming and costly.

Therefore it is an object of the present invention to provide an aero-gas turbine engine arrangement that obviates the above disadvantages, improving transportation and ease of disassembly and assembly.

In accordance with the present invention there is provided a core engine for a gas turbine engine, the core engine having a rotational axis, a casing and further comprises a gearbox assembly, a radial drive arrangement, pipes and connections and a connection structure; the radial drive arrangement drivingly connects the core engine to the gearbox assembly; the pipes and connections extend from the gearbox assembly to the core engine and the gearbox assembly is radially spaced from the casing by connection structure.

The radial spacing of the gearbox assembly from the casing may relate to a radial distance between the casing and a fan casing of a gas turbine engine.

The gearbox assembly may be located radially outwardly of the fan casing.

The connection structure may comprise at least one strut.

The connection structure may comprise a fairing.

The connection structure is removable,

The pipes and connections may include a high pressure fuel line.

The gearbox assembly may comprise any one or more of the group comprising an electronic engine controller, a starter/generator, an oil pump and a fuel pump.

The gearbox assembly comprises a pad to which the connection structure may attach.

In another aspect of the present invention there is provided a gas turbine engine comprising a core engine as described above, wherein the gas turbine engine comprises a fan casing and the pad is releasably attached to the fan casing.

The fan casing may form a slot which releasably engages with the pad.

In a further aspect of the present invention there is provided a method of assembling a gas turbine engine, the gas turbine engine comprises a rotational axis, a core engine and a fan casing; the core engine comprises a casing, a gearbox assembly, a radial drive arrangement, pipes and connections and a connection structure; the radial drive arrangement drivingly connects the core engine to the gearbox assembly; the pipes and connections extend from the gearbox assembly to the core engine and the gearbox assembly is radially spaced from the casing by connection structure, the method comprises the steps of axially translating the core engine and the fan casing so that the gearbox is adjacent the fan casing and attaching the gearbox assembly to the fan casing.

The method may comprise the step of removing the connection structure.

In yet another aspect of the present invention there is provided a method of disassembling a gas turbine engine, the gas turbine engine comprises a rotational axis, a core engine and a fan casing; the core engine comprises a casing, a gearbox assembly, a radial drive arrangement, pipes and connections and a connection structure; the radial drive arrangement drivingly connects the core engine to the gearbox assembly; the pipes and connections extend from the gearbox assembly to the core engine and the gearbox assembly is radially spaced from the casing by connection structure, the method comprises the steps of detaching the gearbox from the fan casing and axially translating apart the core engine and the fan casing.

The method comprising the step of attaching the connection structure between the core engine and the gearbox.

The present invention will be more fully described by way of example with reference to the accompanying drawings in which:

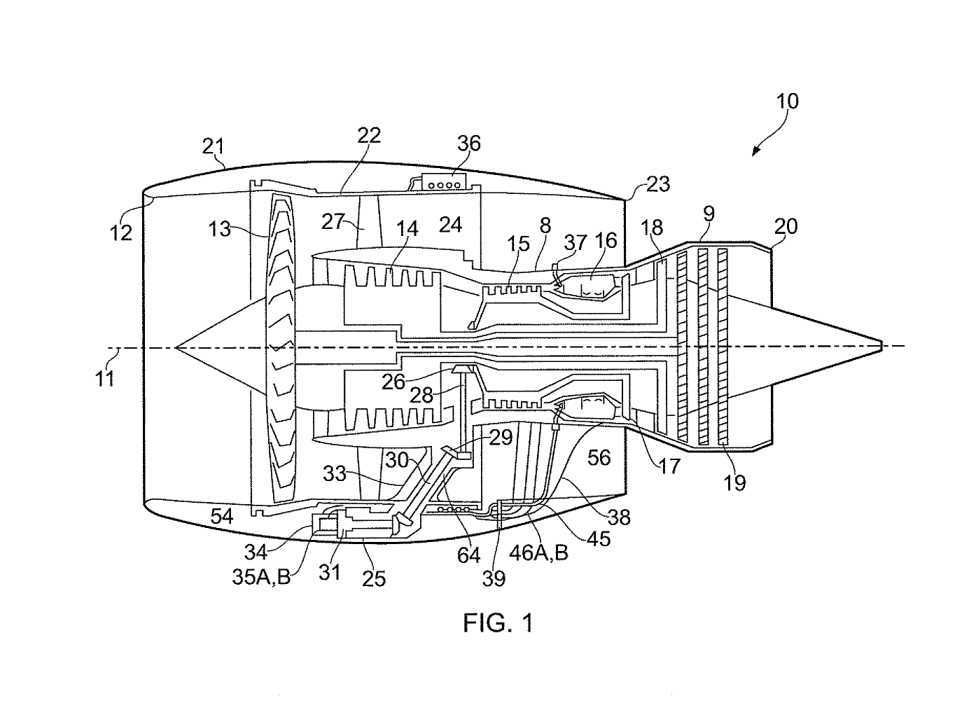

FIG. 1 is a schematic section of part of a known ducted fan gas turbine engine;

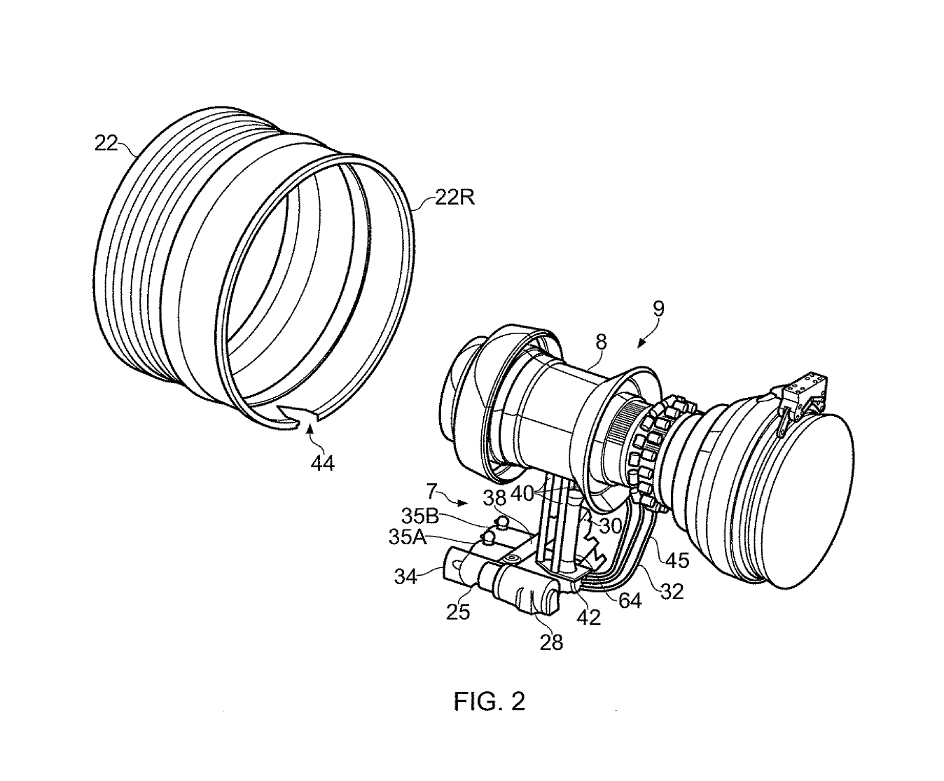

FIG. 2 is a perspective, exploded view of a ducted fan gas turbine engine having a core engine and fan casing arrangement in accordance with the present invention;

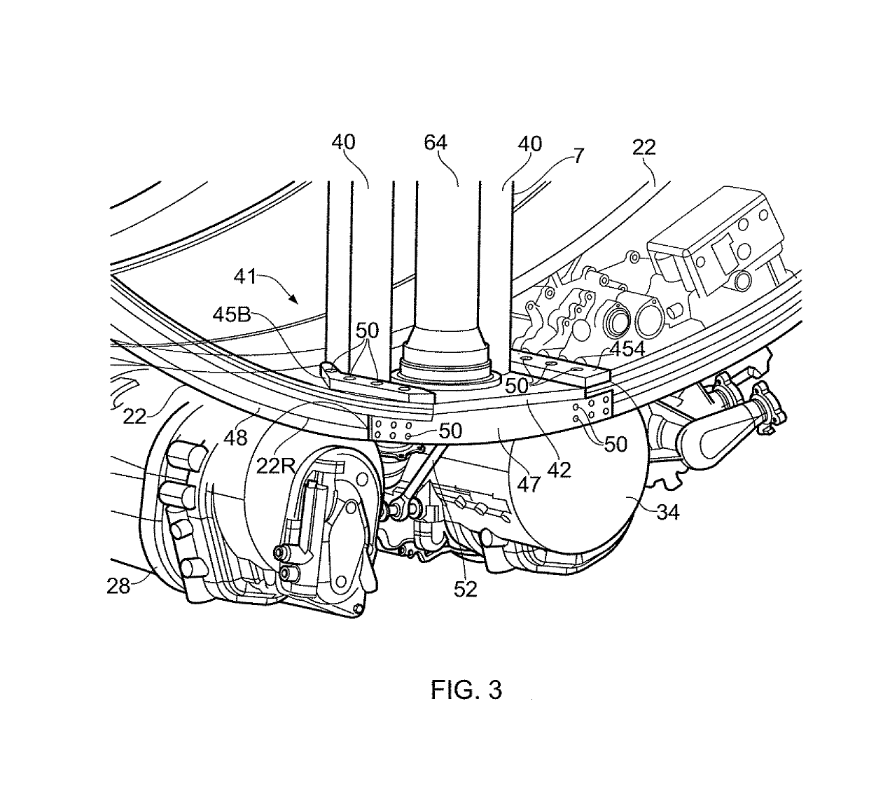

FIG. 3 is an enlarged view of a connection structure between the fan casing and core engine of FIG. 2 and which carries engine accessories;

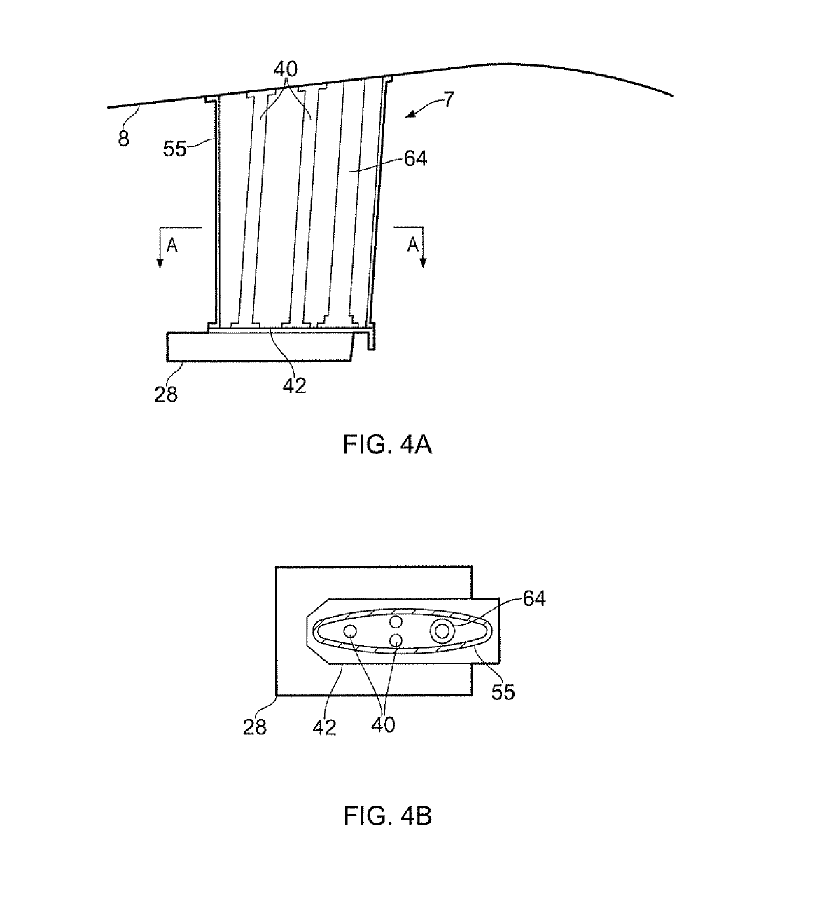

FIG. 4A is a side view of the connection structure;

FIG. 4B is a section A-A through the connection structure in FIG. 4A;

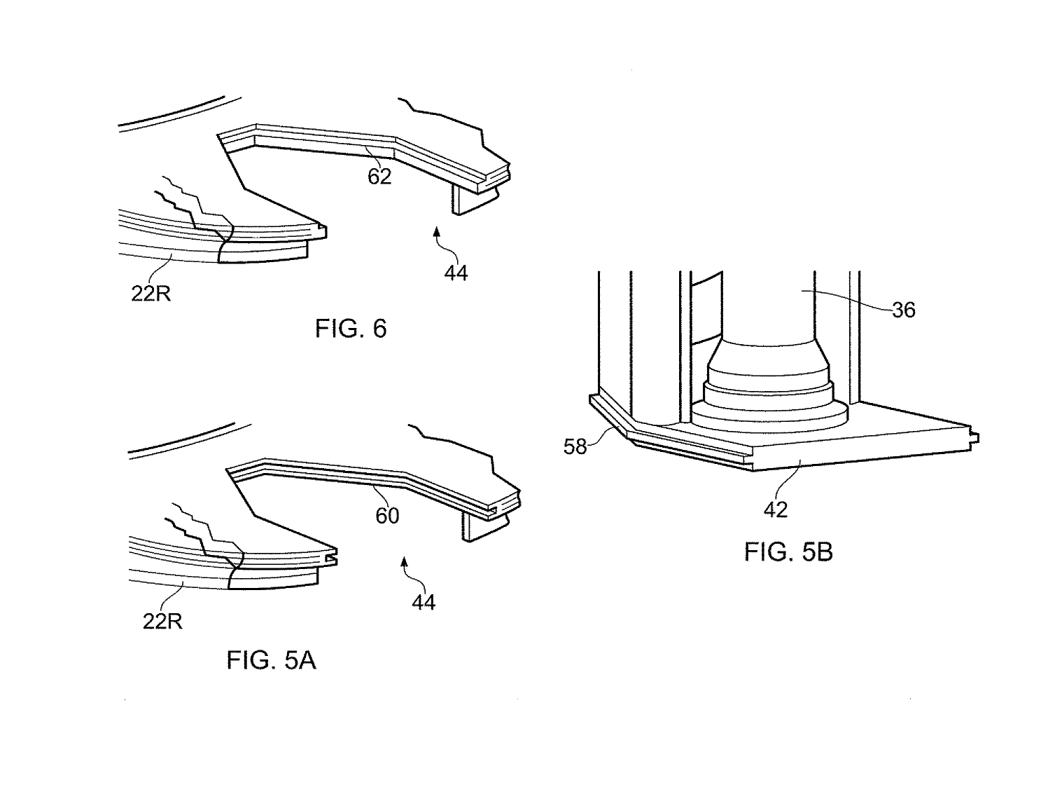

FIGS. 5A and 5B are perspective views of an alternative connection structure; and

FIG. 6 is a perspective view of another connection structure.

With reference to FIG. 1, a ducted fan gas turbine engine generally indicated at 10 has a principal and rotational axis 11. The engine 10 comprises, in axial flow series, an air intake 12, a propulsive fan 13 and a core engine 9 comprising an intermediate pressure compressor 14, a high-pressure compressor 15, combustion equipment 16, a high-pressure turbine 17, and intermediate pressure turbine 18, a low-pressure turbine 19 and a core engine exhaust nozzle 20. The gas turbine engine may also be a two-shaft engine and possibly with a booster compressor as is well known in the art.

The gas turbine engine 10 works in the conventional manner so that air entering the intake 12 is accelerated by the fan 13 to produce two air flows: a first air flow into the intermediate pressure compressor 14 and a second air flow which passes through a bypass duct 24 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high, intermediate and low-pressure turbines 17, 18, 19 respectively drive the high and intermediate pressure compressors 15, 14 and the fan 13 by suitable interconnecting shafts.

The fan 13 is circumferentially surrounded by a structural member in the form of a fan casing 22, which is rigidly connected to and supported by an annular array of outlet guide vanes 27. A nacelle 21 generally surrounds the core engine 9 and fan casing 22 and defines the intake 12, the bypass duct 24 and a bypass exhaust nozzle 23.

The engine 10 further comprises a gearbox assembly 25 used for engine start up and for generating electricity once the engine has been started and working in conventional fashion. The generated electricity is used for engine and associated aircraft electrical accessories as well known in the art. The gearbox/generator assembly 25 is drivingly connected to the high-pressure shaft, however, in other embodiments may be driven by any one or more of the other shafts.

Typically, the gearbox/generator assembly 25 is drivingly connected to the core engine 9 via a radial drive shaft arrangement 64 which comprises an internal gearbox 26 connecting a first drive shaft 28 to the high-pressure shaft, an intermediate gearbox 29 connecting the first drive shaft 28 to a second drive shaft 30 and an external gearbox 25 drivingly connected to the second drive shaft 30. The external gearbox 25 is drivingly connected to a starter/generator 34 that is capable of the aforesaid electrical generation as well as being used to start the engine and is well known in the art. The starter/generator 34 and external gearbox 31 are permanently mounted on the external surface of the fan casing 22 and housed within the nacelle 21. The first drive shaft 28, intermediate gearbox 29 and the second drive shaft 30 are housed within a bypass duct splitter fairing 33. Also mounted on and driven via the gearbox 31 are a number of engine accessories including fuel and oil pumps 35A, 35B, only one of which is shown for clarity.

Other accessories, such as the engine control unit or FADEC 36 are also mounted on the fan casing 22. These accessories are connected to components in the core engine 9, such as fuel injectors 37, and as can be seen in FIG. 1, numerous pipes and cables 38, only some of which are shown for clarity, connect between the accessories and the components of the core engine 9.

For assembly and disassembly of the fan case 22 to the core engine 24 the pipes and cables 38 are connected/disconnected and for this purpose a disconnect panel 39 is provided. The fan case 22 is also disconnected from the outlet guide vane array 27. The fan 13 blades are removed from the engine prior to the removal of the fan casing 22.

The fan casing 22 is only removed and replaced at its initial assembly factory or an engine overhaul base because there are certification constraints with respect to disconnecting and re-connecting a number of high pressure fuel lines 45 and other pipes, cables and other services 38. Thus the current engine must be transported with the fan casing 22 assembled to the core engine 9. Particularly, but not exclusively, with today's very high bypass engines the fan casing diameter is such that transportation becomes very difficult, time consuming and costly.

Referring now to FIGS. 2 and 3 that schematically shows an exemplary embodiment of the present invention that solves the above mentioned problems. Like components have the same reference numbers as in FIG. 1. The core engine 9 assembly now comprises the external gearbox 31, accessories 34, 35 and FADEC 36 mounted to it, via a connection structure 7, rather than being mounted to the casing 22 as seen in the and described with reference to FIG. 1. The fan casing 22 is removable from the core engine 9 without the necessity to disconnect the drive shaft 64 and connections 46A, 46B (see FIG. 1) from accessories 35A, 35B mounted on the gearbox and in particular, the high-pressure fuel line 45 from the fuel pump 35B to the fuel injectors 37, oil scavenge lines and electrical connections generally indicated at 32.

The gearbox assembly 25, including the gearbox 31 and other accessories 34, 35, is mounted on a chassis 28 that is mounted to a casing 8 of the core engine 9 via struts 40. In this example three struts are shown, but in other cases one, two, four or more struts or other structural connection may be used. The chassis 28 is preferably formed by the gearbox casing as shown or is integral thereto, but may be a separate element to which the gearbox and other accessories are mounted. For example, one such arrangement comprises a raft 38, shown in dashed lines, which could be used to mount the gearbox 31 and other accessories. The three struts 40 support a reinforcement pad 42 that is attached to the chassis 28. Where the radial drive shaft 64 intersects a rear portion 22R of the fan casing 22, the reinforcement pad 42 is shaped to engage in a correspondingly shaped slot 44 defined in a rear section 22R of the fan casing 22. The reinforcement pad 42 and slot 44 are releasably connected via a bolted assembly to further secure the gearbox and accessories along with the connection structure 7.

Referring to FIG. 3, a releasable connector 41 connects between the IS reinforcement pad 42 and the fan casing 22. The reinforcement pad 42 comprises a pair of opposing and laterally (circumferentially) extending flanges 45A, 45B and a radially extending flange 47. The flanges 45A, 45B are bolted in a generally radial direction through the fan case 22 thereby securely fastening the reinforcement pad 42 and the fan casing 22 together. The bolts are omitted for clarity, but are indicated by the dashed lines 50. The flange 47 is bolted in a generally axial direction through a stiffening ring 48 or flange of the fan casing 22. In service the bolts and flanges within the fancase will be situated under (radially outwardly of) acoustic panels (not shown) which are attached to the radially inner surface of the fan case 22 and so will not disturb the fan airflow in the bypass duct 24. This releasable connector or joint arrangement 41 carries the loads of the gearbox via a suspension strut 52 and locates the radial drive shaft 64.

The reinforcement pad 42 and its associated releasable connector 41 are designed in such a way as to ensure that it acts as a gas and fire proof boundary between the interior chamber 54 of the nacelle 21 and the cavity 56 defined in the lower bifurcation 33 of the engine and as shown in FIG. 1. The join between the reinforcement pad 42 and the fan casing 22 may include combined or separate fire and leakage prevention seals.

FIGS. 4A and 4B show the connection structure 7 in more detail. The struts 40 extend between and are attached to the fan casing 22 and the core engine casing 8. The struts 40 are removable once the fan casing 22 is engaged to the reinforcement pad 42 and the outlet guide vane array 27 are connected between the core engine 9 and fan casing 22,

FIGS. 4A and 4B also show a fairing 55 surrounding the connection structure 7 and drive shaft 64. This fairing 55 is for aerodynamic purposes, however, although the struts 40 are shown connecting between the core engine 9 and the chassis 28, in an alternative embodiment the fairing may be made sufficiently sturdy to replace the function of the struts 40. Therefore the struts may be omitted. Once the connection structure 7 is attached to the fan casing it is supported at each radially inward and outward end and is therefore a rigid Is support for engine and aircraft flight operations.

In FIGS. 5A and 5B, an alternative detachable connection 7 between the fan casing 22 and the pad 42 is shown. This detachable connection 7 comprises a tongue and groove arrangement where the pad comprises a tongue 58 extending around part of the pas 42 and a corresponding groove 60 extending around the periphery of the cut-out or slot 44. A seal may be located within or about the tongue and groove to prevent fire and/or gas leakage. The tongue may be slid into the groove and cooperating and radially extending flanges 47 (as shown in FIG. 3) may be included and bolted together to further secure the assembly.

FIG. 6 shows an alternative to the tongue and groove detachable connection, where a simple lap joint 62 is provided. Again a seal may be located within or about the lap joint 62 to prevent fire and/or gas leakage. The overlapping pad and fan casing comprises radially extending flanges 47 (as shown in FIG. 3) which can be bolted together to further secure the assembly.

The slot 44 in the rear of the fan casing is required because of the position of the radial drive shaft 64. However, in some applications the radial drive shaft 64 may be positioned so that it is axially rearward of the fan casing and in this case the pad 42 may extend axially forwardly to overlap the fan casing 22 and be bolted thereto. Thus there is no slot or other cut-out in the casing other than bolt holes where necessary. Alternatively, cooperating and radially extending flanges 47 (as shown in FIG. 3) at the axially forward edge of the pad 42 and rearward edge of the fan casing 22 to secure the assembly together. This is preferable where hoop stresses in the fan casing do not permit the slot 44 or other cut-out. However, where there is a slot the bolted connections are design to carry hoop and other stresses across the slot 44.

For clarity the connection structure 7 preferably comprises the struts 40 and drive shaft arrangement 64, the struts 40 are removable once the core engine 9 and fan case 22 are assembled together in order to reduce weight. Alternatively, the fairing 55 may form part of the connection structure 7 along with the struts 40 where fewer struts can be used. Still further the fairing 55 may be fabricated and attached to the casing 8 and fan casing 22 to form a rigid connection for mounting the gearbox and the struts 40 may therefore be omitted.

Prior to assembly of the core engine 9 and fan case 22; the core engine 9 comprises the connection structure 7 on which is mounted the gearbox 25 and other accessories and the fan case assembly 22 comprises the array of outlet guide vanes 27. The fan case 22 may also comprise A-frame struts to transfer loads (in conjunction with the outlet guide vanes 27) between the core engine and fan case/nacelle. The method of assembling the fan case assembly 22 to the core engine 9 comprises translating the two assemblies axially into their axial connection positions with the mount pad 42 engaging the rear of the fan case 22R; attaching the mount pad 42 to the rear of the fan case 22R and possibly removing the struts 40. Where the fairing 55 is for aerodynamic purposes only then it may be attached to surround the drive radial shaft arrangement 64 and pipe work 32. The method of disassembling the fan case assembly 22 and the core engine 9 is simply the reverse process.

It should be noted that the arrangement of the present invention does not have any disconnection of the piping and electrical connections 32 and significantly the high pressure fuel line 45. It is therefore possible to disconnect the fan case 22 from the core engine 9 relatively easily without the inherent problems of disconnecting piping and electrical connections 32 between the gearbox and accessories mounted on the mount pad 42 and the core engine 9. Furthermore, it should be apparent to the skilled reader that transportation of the engine 10, excluding the nacelle 21, is made easier by virtue of the reduced size of the two separated assemblies (fan case and core engine). Previously the fan case and core engine would require transportation in their assembled state.

1. A core engine for a gas turbine engine, the core engine having a rotational axis, a casing and further comprises
a gearbox assembly,
a radial drive arrangement,
pipes and connections and
a connection structure;
the radial drive arrangement drivingly connects the core engine to the to gearbox assembly;
the pipes and connections extend from the gearbox assembly to the core engine and
the gearbox assembly is radially spaced from the casing by the connection structure.

2. A core engine as claimed in claim 1 wherein the radial spacing of the gearbox assembly from the casing relates to a radial distance between the casing and a fan casing of a gas turbine engine.

3. A core engine as claimed in claim 2 wherein the gearbox assembly is located radially outwardly of the fan casing.

4. A core engine as claimed in claim 1 wherein the connection structure comprises at least one strut.

5. A core engine as claimed in claim 1 wherein the connection structure comprises a fairing.

6. A core engine as claimed in claim 1 wherein the connection structure is removable.

7. A core engine as claimed in claim 1 wherein the pipes and connections include a high pressure fuel line.

8. A core engine as claimed in claim 1 wherein the gearbox assembly comprises any one or more of the group comprising an electronic engine controller, a starter/generator, an oil pump and a fuel pump.

9. A core engine as claimed in claim 1 wherein the gearbox assembly comprises a pad to which the connection structure attaches.

10. A gas turbine engine comprising a core engine as claimed in claim 9, wherein the gas turbine engine comprises a fan casing; the pad is releasably attached to the fan casing.

11. A gas turbine engine as claimed in claim 10 wherein the fan casing forms a slot which releasably engages with the pad.

12. A method of assembling a gas turbine engine, the gas turbine engine comprises a rotational axis, a core engine and a fan casing;
the core engine comprises a casing, a gearbox assembly, a radial drive arrangement, pipes and connections and a connection structure;
the radial drive arrangement drivingly connects the core engine to the gearbox assembly; the pipes and connections extend from the gearbox assembly to the core engine and the gearbox assembly is radially spaced from the casing by connection structure,
the method comprises the steps of
axially translating the core engine and the fan casing so that the gearbox is adjacent the fan casing and
attaching the gearbox assembly to the fan casing.

13. A method of assembling a gas turbine engine as claimed in claim 11, the method comprising the step of removing the connection structure.

14. A method of disassembling a gas turbine engine, the gas turbine engine comprises a rotational axis, a core engine and a fan casing;
the core engine comprises a casing, a gearbox assembly, a radial drive arrangement, pipes and connections and a connection structure; the radial drive arrangement drivingly connects the core engine to the gearbox assembly; the pipes and connections extend from the gearbox assembly to the core engine and the gearbox assembly is radially spaced from the casing by connection structure,
the method comprises the steps of
detaching the gearbox from the fan casing and
axially translating apart the core engine and the fan casing.

15. A method of disassembling a gas turbine engine as claimed in claim 14, the method comprising the step of attaching the connection structure between the core engine and the gearbox.
